(19) United States
(12) Patent Application Publication
(10) Pub. No.: US 2019/0025074 A1
(43) Pub. Date: Jan. 24, 2019

(54) SYSTEM AND METHOD FOR IMPROVED MOBILE NAVIGATION

(71) Applicant: Faraday&Future Inc., Gardena, CA (US)

(72) Inventors: Xinghui Sun, San Jose, CA (US); YongGe Hu, San Jose, CA (US)

(21) Appl. No.: 15/720,158

(22) Filed: Sep. 29, 2017

Related U.S. Application Data
(60) Provisional application No. 62/402,933, filed on Sep. 30, 2016.

(51) Int. Cl. G01C 21/36

(52) U.S. Cl. CPC G01C 21/3697; G01C 21/3608; G01C 21/3664; G01C 21/3682

(57) ABSTRACT

Methods, systems, computer-readable media, and apparatuses for providing a navigation route to a user are presented. In some embodiments, a method for providing a navigation route to a user includes receiving, via a device, an input indicative of at least one destination location. The method also includes generating, via a processor on the device, a navigation route from a source location to the at least one destination location. The method additionally includes displaying, within a user interface (UI) on a display of the device, the generated navigation route. The method additionally includes in response to at most one user input or without any user input, displaying at least one actionable function pertaining to the at least one destination location. The at least one actionable function is displayed within the UI during an ongoing navigation process. The at least one actionable function is selectable by the user.

### CROSS-REFERENCE TO RELATED APPLICATIONS

This application claims the benefit of U.S. Provisional Application No. 62/402,933, filed Sep. 30, 2016, the entirety of which is hereby incorporated by reference.

### BACKGROUND

Aspects of the disclosure relate to improvements in mobile navigation systems. Many users employ navigation systems and software on a device (e.g., smartphone or in-vehicle navigation systems) to obtain directions for traveling from a source to a destination. However, many functions within the navigation system's user interface (UI) become unavailable once a user begins the navigation process. To access these functions, the user may be required to provide multiple inputs through different menus or may need to exit the navigation process altogether. Embodiments described herein solve these issues, both individually and collectively.

### BRIEF SUMMARY

Certain embodiments are described for improved mobile navigation.

In some embodiments, a method for providing a navigation route to a user includes receiving, via a device, an input indicative of at least one destination location. The method also includes generating, via a processor on the device, a navigation route from a source location to the at least one destination location. The method additionally includes displaying, within a user interface (UI) on a display of the device, the generated navigation route. The method further includes in response to at most one user input or without any user input, displaying at least one actionable function pertaining to the at least one destination location. The at least one actionable function is displayed within the UI during an ongoing navigation process. The at least one actionable function is selectable by the user.

In some embodiments, the method also includes preloading into a memory, via the processor, at least one item of information pertaining to the destination location.

In some embodiments, the at least one item of information comprises at least one of: a phone number of the at least one destination location, a website address of the at least one destination location, a business hours listing of the at least one destination location, a review rating of the at least one destination location, an e-mail address of the at least one destination location, or an address of the at least one destination location.

In some embodiments, the at least one actionable function is dynamically displayed within the UI.

In some embodiments, the at least one actionable function is displayed within the UI according to a semi-transparent fill factor.

In some embodiments, the at least one actionable function is selectable by the user via a voice command.

In some embodiments, the method also includes, in response to the user selecting the at least one actionable function, displaying, within the UI, one or more additional actionable functions pertaining to the at least one destination location.

In some embodiments, a system for providing a navigation route to a user includes a processor and a computer readable medium coupled to the processor, the computer readable medium comprising code, executable by the processor, for implementing a method. The method includes receiving an input indicative of at least one destination location, generating a navigation route from a source location to the at least one destination location, displaying within a user interface (UI) on a display of the device, the generated navigation route, and in response to at most one user input or without any user input, displaying at least one actionable function pertaining to the at least one destination location, wherein the at least one actionable function is displayed within the UI during an ongoing navigation process, and wherein the at least one actionable function is selectable by the user.

In some embodiments, an apparatus for providing a navigation route to a user includes means for receiving, via a device, an input indicative of at least one destination location, means for generating, via a processor on the device, a navigation route from a source location to the at least one destination location, means for displaying, within a user interface (UI) on a display of the device, the generated navigation route, and in response to at most one user input or without any user input, displaying at least one actionable function pertaining to the at least one destination location, wherein the at least one actionable function is displayed within the UI during an ongoing navigation process, and wherein the at least one actionable function is selectable by the user.

### BRIEF DESCRIPTION OF THE DRAWINGS

Aspects of the disclosure are illustrated by way of example. In the accompanying figures, like reference numbers indicate similar elements.

FIG. 1 illustrates an existing navigation user interface (UI) on a device.

FIG. 2 is a block diagram of a device 200, according to some embodiments.

FIG. 3 illustrates a navigation UI 310 with quick-access functionality, according to some embodiments.

FIG. 4 illustrates a navigation UI 310 with a different quick-access functionality, according to some embodiments.

FIG. 5 illustrates a navigation UI 310 with destination information functionality, according to some embodiments.

FIG. 6 illustrates a navigation UI 310 with a quick-access destination icon 630 providing multiple information and/or action options.

FIG. 7 illustrates an example of a computing system in which one or more embodiments may be implemented.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

As described above, current functions within a navigation system's user interface (UI) become unavailable once a user begins the navigation process. To access these functions, the user may be required to provide multiple inputs through different menus or may need to exit the navigation process altogether. This can be both tedious and unsafe for the user to perform while operating a vehicle. In some situations, the user may even be required to restart the navigation process after obtaining the functionality the user desires. Existing solutions do not provide a user with quick access to functions/operations that may be desired by the user during the navigation process.

Many situations exist where a user may need access to certain functionalities/operations while the navigation process is ongoing. For example, a user may be driving to a destination and desire to place a phone call to the destination during the drive while the navigation process is ongoing. In another example, a user may be driving to a destination and may desire for quick access to the business hours of the destination.

Embodiments of the invention provide quick access to multiple functionalities within a navigation application while the navigation process is ongoing.

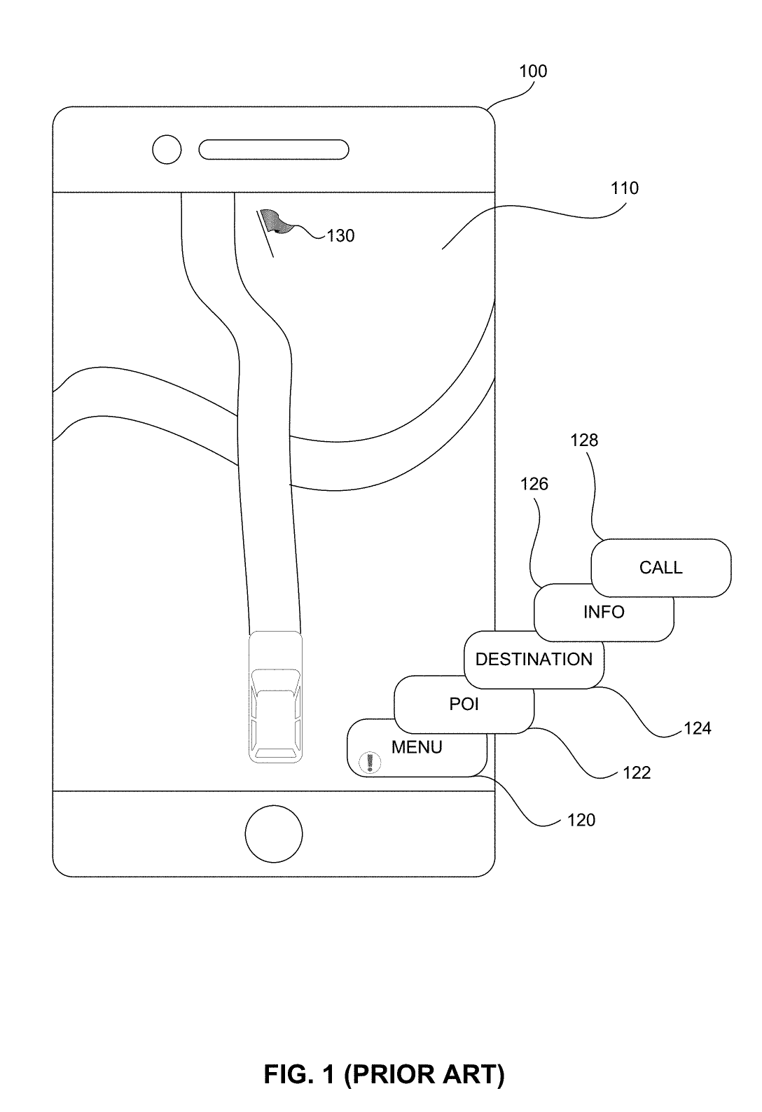

FIG. 1 illustrates an existing navigation UI 110 on a device 100. The existing navigation UI 110 displays a navigation route from a user's current position (indicated by the location of the vehicle icon within the UI) to a destination 130. The existing navigation UI 110 is displayed on a display of the device 100. In one example, the device 100 may be a smartphone. The existing navigation UI 110 may be generated by navigation software being executed on the device 100. Prior to beginning a journey in the user's vehicle, the user may have entered a destination address within the navigation software. The user may then begin his/her journey in the vehicle toward the destination 130, under the guidance of the navigation software.

As described above, there may be many instances where the user may wish to interact with the existing navigation UI 110 to obtain some information or execute an action. For example, the information/action may comprise obtaining the phone number of the destination 130 and placing a phone call to the destination 130 (e.g., via the device 100 or via an in-car hands free phone system). Other examples of the information/action the user may wish to obtain or execute include, but is not limited to, obtaining and viewing business hours of the destination 130, obtaining and viewing user reviews of the destination 130, obtaining and/or viewing a website address of the destination 130, obtaining and/or sending an e-mail to an e-mail address associated with the destination 130, or obtaining and/or viewing an address associated with the destination 130.

The existing navigation UI 110 includes a menu icon 120. The menu icon 120 may be accessed by the user with a “touch” on the display over the location of the menu icon 120. In the existing solution, the user touches the menu icon 120 in order to obtain information or execute an action according to the one of the examples described above. After touching the menu icon 120, the user may be provided with a sub-menu, within the existing navigation UI 110, displaying one or more other options. The sub-menu many include further options (shown as icons) related to selecting the menu icon 120. For example, the sub-menu related to the menu icon 120 can include a point of interest (POI) icon 122 among other icons (not shown). The point of interest may be the destination 130. The user must then select the POI icon 122 to further narrow down the sub-menu into a further sub-menu showing options related to the POI icon 122. Similarly, the user must then select the destination icon 124 in the POI sub-menu, the information icon 126 in the destination sub-menu, and finally the call icon 128 in the information sub-menu.

As illustrated, the user is required to navigate through many sub-menus to finally be able to reach the call icon 128 in order to call the destination 130. This creates problems for the user. These problems include safety concerns as the user is required to provide multiple inputs to the existing navigation UI 110 in order to obtain the information or execute the action that he/she desires. The user's attention may be misdirected from concentrating on operating his/her vehicle. Additionally, the user may be frustrated with the number of inputs required to finally reach the simple action of calling the destination 130. These are just a few examples of the problems posed by the existing navigation UI 110. The following figures describe an improvement on the existing navigation UI 110.

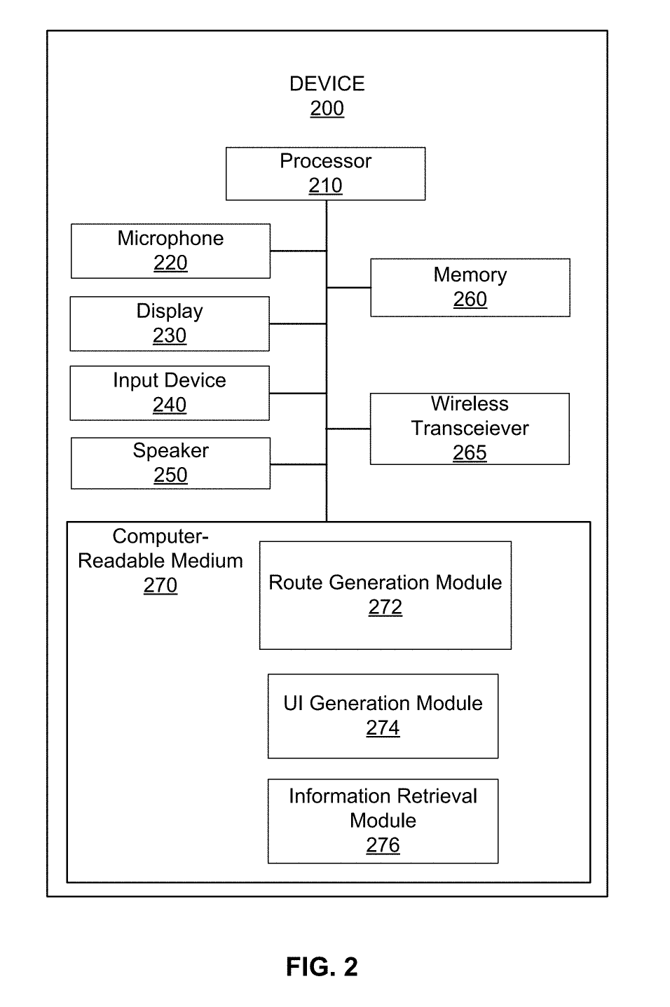

FIG. 2 is a block diagram of a device 200, according to some embodiments. The device 200 includes a processor 210, a microphone 220, a display 230, an input device 240, a speaker 250, a memory 260, and a computer-readable medium 270.

Processor 210 may be any general-purpose processor operable to carry out instructions on the mobile communication device 200. The processor 210 is coupled to other units of the mobile communication device 200 including microphone 220, display 230, input device 240, speaker 250, memory 260, and computer-readable medium 270.

Microphone 220 may be any device that converts sound to an electric signal. In some embodiments, microphone 220 may be used to capture voice data from a user.

Display 230 may be any device that displays information to a user. Examples may include an LCD screen, CRT monitor, or seven-segment display. In some embodiments, the display 230 may be a touch-screen display.

Input device 240 may be any device that accepts input from a user. Examples may include a keyboard, keypad, or mouse. In some embodiments, microphone 220 may be considered an input device 240.

Speaker 250 may be any device that outputs sound to a user. Examples may include a built-in speaker or any other device that produces sound in response to an electrical audio signal. In some embodiments, speaker 250 may be used to provide feedback to the user via the navigation application/software.

Memory 260 may be any magnetic, electronic, or optical memory. An example of memory 260 may be dynamic random access memory (DRAM).

Wireless transceiver 265 may be operable to transmit and receive a wireless data via an antenna. The wireless transceiver 370 may be transmit and receive data via a wireless network. In some embodiments, the wireless network may be any wireless network such as, but not limited to, the Internet, WiFi, Bluetooth, IR, ZigBee, a Personal Access Network (PAN), or a cellular network (e.g. a GSM, WCDMA, LTE, CDMA2000 network). In some embodiments, the wireless transceiver 265 may be used to communicate with one or more satellite positioning systems via the navigation application/software.

Computer-readable medium 270 may be any magnetic, electronic, optical, or other computer-readable storage medium. Computer-readable medium 270 includes route generation module 272, UI generation module 274, and information retrieval module 276. Computer-readable medium 270 may comprise any combination of volatile and/or non-volatile memory such as, for example, buffer memory, RAM, DRAM, ROM, flash, or any other suitable memory device, alone or in combination with other data storage devices.

Route generation module 272 is configured to, when executed by processor 210, generate a navigation route from the device 200's current position to a destination location provided by a user. The user may input a destination location via, for example, the input device 240 or by providing a touch input to the display 230. The route generation module 272 may interface with one or more satellite positioning systems, via wireless transceiver 265, to obtain the current location of the device 200 in order to generate the navigation route from the current location to the destination input by the user. The destination location provided by the user may be, for example, a physical address of the destination location. The route generation module 272 may determine an optimal route along public or private roads travelable by the user's vehicle from the device 200's current position to the destination location.

UI generation module 274 is configured to, when executed by processor 210, generate a UI for the navigation software/application. The UI generation module 274 may generate a UI that includes a map of an area covering a default and/or user-defined distance around the device 200. The map may also include the route generated by the route generation module 272. Additionally, the map may include one or more quick-access menu icons configured to provide the user with access to obtaining information or executing an action pertaining to the destination location or any other location.

Information retrieval module 276 is configured to, when executed by processor 210, retrieve information pertaining to the destination location from one or more sources. After the user inputs the destination and substantially simultaneous to the route generation module 272 generating the navigation route and the UI generation module 274 generating the UI for the navigation software/application, the information retrieval module 276 may retrieve information pertaining to the destination location from one or more sources. The one or more sources may include, but is not limited to, a local database (not shown) residing on the device 200, a database located on a remote server, and/or one or more crowd-sourced devices.

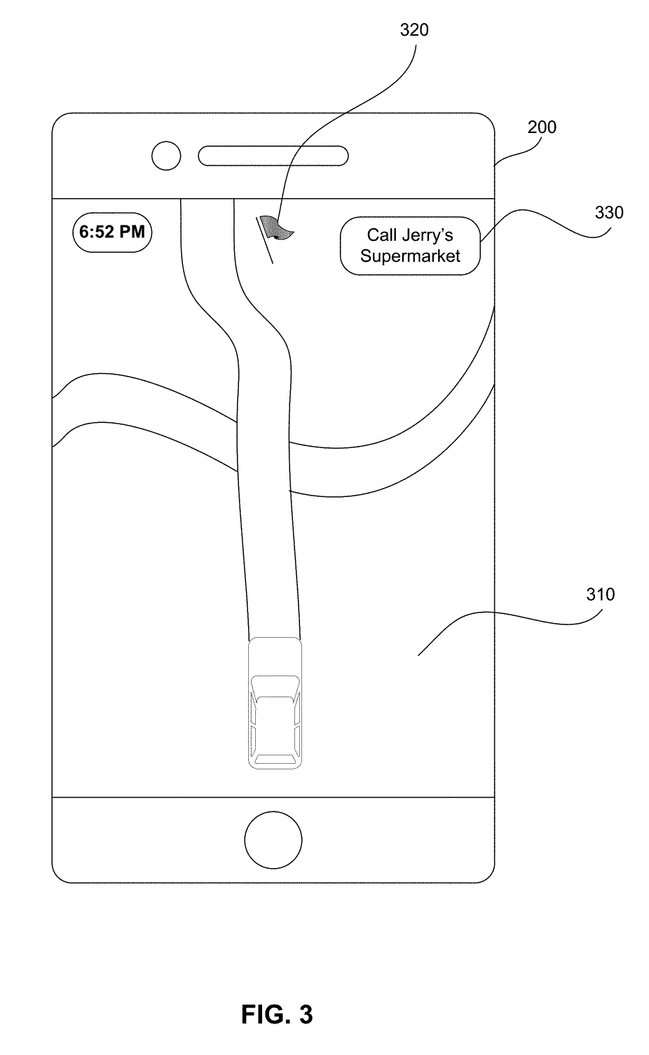

FIG. 3 illustrates a navigation UI 310 with quick-access functionality, according to some embodiments. The navigation UI 310 may be displayed on the display 230 of the device 200. As described above, a user of the device 200 may intend to begin a journey in his/her vehicle to a destination. Prior to, or at some time during, the user's journey, the user may input a destination location to the navigation application/software running on the device 200, via input device 240 or by touching the display 230. Upon receiving the user's input of the destination location, the route generation module 272 may generate a route from the current location of the mobile 200 to the destination location, as described above with respect to FIG. 2. Upon the route generation module 272 generating the route, the UI generation module 274 may generate a navigation UI 310 that includes a map of the area surrounding the device 200 and also indicating the route generated by the route generation module 272 from the location of the device 200 to the destination location 320. Further, the UI generation module 274 may generate a quick-access call icon 330 configured to provide one-touch input for the user to call an establishment at the destination location 320. For example, the quick-access call icon 330 can be configured to, upon an input (e.g., touch input) by the user, place a phone call to the destination location 320 (Jerry's Supermarket) via the device 200. The quick-access call icon 330 may be generated by the UI generation module 274 based upon information retrieved from the information retrieval module 276. As described above, the information retrieval module 276 may retrieve, substantially simultaneous to the route generation module 272 receiving the user input, information pertaining to the destination location 320 input by the user.

As illustrated, the user may be able to quickly and safely place a call to the destination location 320 using the quick-access call icon 330. The user does not need to navigate through multiple sub-menus using multiple inputs in order to achieve his/her desired action of placing a call to the destination location 320. Rather, the user may simply need to touch the quick-access call icon 330. This may allow for the user to place a call to the destination location 320 by only providing one input or touch command to the device 200. The user may not need to unnecessarily divert his attention from the road when operating his/her vehicle. Further, the user will have increased satisfaction with the navigation application/software because of the ease of use in being able to successfully obtain the information or execute the action that he/she wishes.

In some embodiments, the quick-access call icon 330 may be semi-transparent such that it does not take away the user's attention from the navigation route displayed within the navigation UI 310. For example, the quick-access call icon 330 may be displayed at 50% transparency over the map and navigation route within the navigation UI 310.

In some embodiments, the quick-access call icon 330 may also be accessed by the user via a voice command. For example, the microphone 220 may accept a voice command from the user that triggers the quick-access call icon 330. In some embodiments, the microphone 220 may be in an “always-on” listening mode such that it may be listening for a trigger word provided by the user. For example, the user may speak “call destination” and the microphone 220 may convert the audio signal into digital data and pass the digital data to the navigation software/application. The navigation software/application may then analyze the digital data for the trigger word and appropriately trigger the quick-access call icon. Alternatively or additionally, separate speech-recognition software separate from the navigation software/application may analyze and convert the digital voice data into commands/trigger words. This example further illustrates how the quick-access call icon 330 provides for safe, intuitive, and more efficient input from the user to obtain information and/or execute an action.

In some embodiments, the quick-access call icon 330 may be dynamic such that the icon may update to reflect other information or another action based on a change in the destination location 320. For example, if the user updates the destination location 320 with an intermediary destination to reflect the user's desire to stop at another location before making his/her way to the originally entered destination location 320, the quick-access call icon 330 may update to reflect information or another action associated with the intermediary destination. In some embodiments, the navigation UI 310 may present more than one quick-access call icon 330 to reflect each intermediary destination and final destination on a user's journey.

Displaying the quick-access call icon 330 within the UI 310 is an example of in response to at most one user input or without any user input, displaying at least one actionable function pertaining to the at least one destination location.

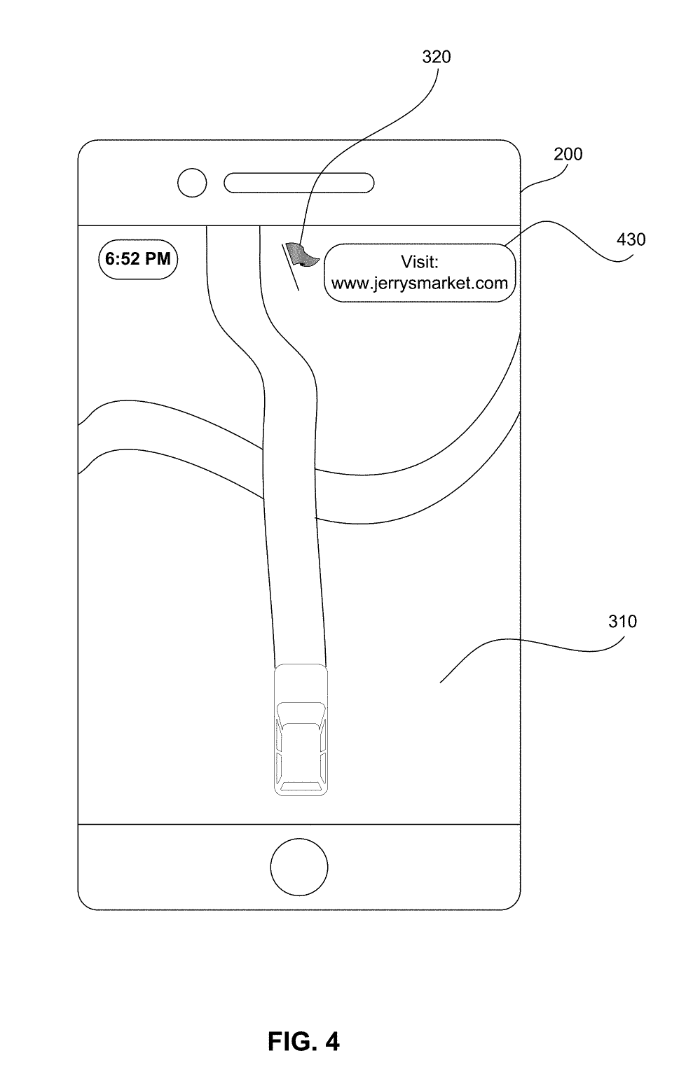

FIG. 4 illustrates a navigation UI 310 with a different quick-access functionality, according to some embodiments. In this example, the navigation UI 310 includes a quick-access website icon 430. The quick-access website icon 430 may function similarly to the quick-access call icon 330 discussed with respect to FIG. 3. For example, the user may provide an input, touch, or voice command to the device 200 to trigger the quick-access website icon 430. The quick-access website icon 430, when triggered, may display, via display 230, a website of the destination location 320. In some embodiments, the website may be displayed such that it only occupies half of the navigation UI 310, so that the user may continue to view the navigation route being displayed.

In some embodiments, the quick-access website icon 430 may be semi-transparent such that it does not take away the user's attention from the navigation route displayed within the navigation UI 310. For example, the quick-access website icon 430 may be displayed at 50% transparency over the map and navigation route within the navigation UI 310.

In some embodiments, the quick-access website icon 430 may be dynamic such that the icon may update to reflect other information or another action based on a change in the destination location 320. For example, if the user updates the destination location 320 with an intermediary destination to reflect the user's desire to stop at another location before making his/her way to the originally entered destination location 320, the quick-access website icon 430 may update to reflect information or another action associated with the intermediary destination. In some embodiments, the navigation UI 310 may present more than one quick-access website icon 430 to reflect each intermediary destination and final destination on a user's journey.

Displaying the quick-access website icon 430 within the UI 310 is an example of in response to at most one user input or without any user input, displaying at least one actionable function pertaining to the at least one destination location.

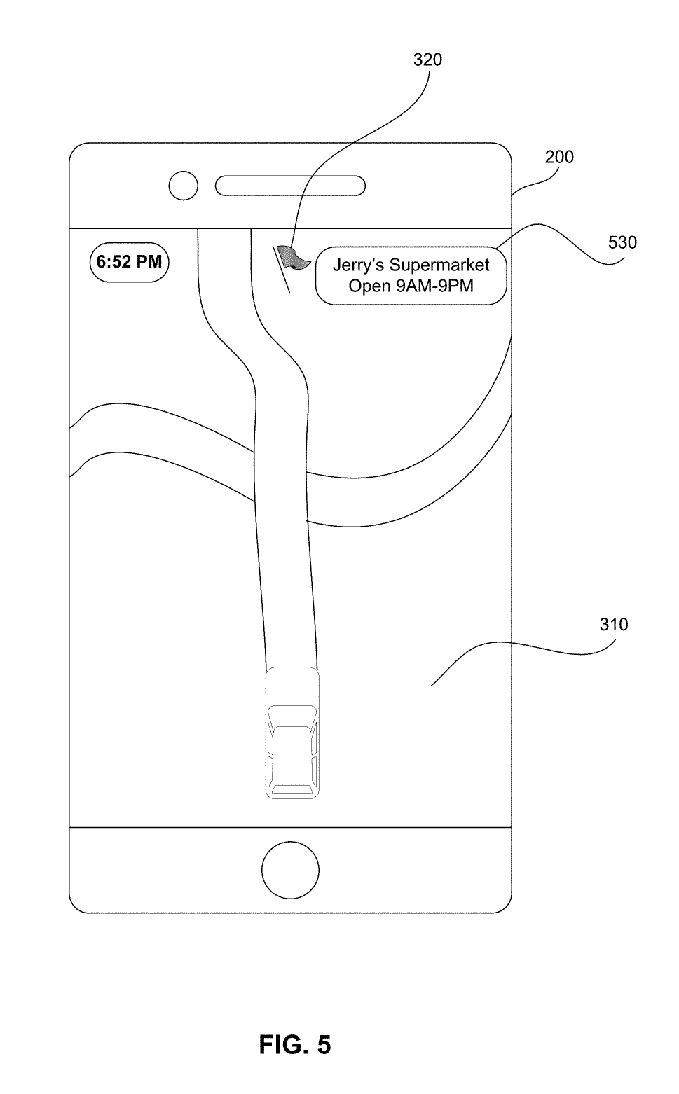

FIG. 5 illustrates a navigation UI 310 with destination information functionality, according to some embodiments. In this example, the navigation UI 310 includes a destination hours information icon 530. The destination hours information icon 530 provides, within the navigation UI 310, information pertaining to the destination location 320 viewable by the user. In this example, the information pertaining to the destination location 320 includes the business hours of the destination location 320. The destination hours information icon 530 may be generated by the UI generation module 274 based upon information retrieved from the information retrieval module 276. As described above, the information retrieval module 276 may retrieve, substantially simultaneous to the route generation module 272 receiving the user input indicating the destination location 320, information pertaining to the destination location 320. The destination hours information icon 530 provides the user with easy-to-find important information about the destination location 320, without unnecessarily distracting the user from operating the vehicle or requiring the user to provide multiple inputs and navigate through multiple menus in order to locate the information. Additionally, similar to what is described above, the destination hours information icon 530 may be displayed within the navigation UI 310 in a semi-transparent fashion. For example, the destination hours information icon 530 may be displayed at 50% transparency over the map and navigation route within the navigation UI 310. The destination hours information icon 530 is just one example of the type of information that can be presented in an information icon within the navigation UI 310. There may be many other types of information that can be presented for the user's benefit while operating the navigation application/software.

In some embodiments, the destination hours information icon 530 may be dynamic such that the icon may update to reflect other information or another action based on a change in the destination location 320. For example, if the user updates the destination location 320 with an intermediary destination to reflect the user's desire to stop at another location before making his/her way to the originally entered destination location 320, the destination hours information icon 530 may update to reflect information or another action associated with the intermediary destination. In some embodiments, the navigation UI 310 may present more than one destination hours information icon 530 to reflect each intermediary destination and final destination on a user's journey.

Displaying the destination hours information icon 530 within the UI 310 is an example of in response to at most one user input or without any user input, displaying at least one actionable function pertaining to the at least one destination location.

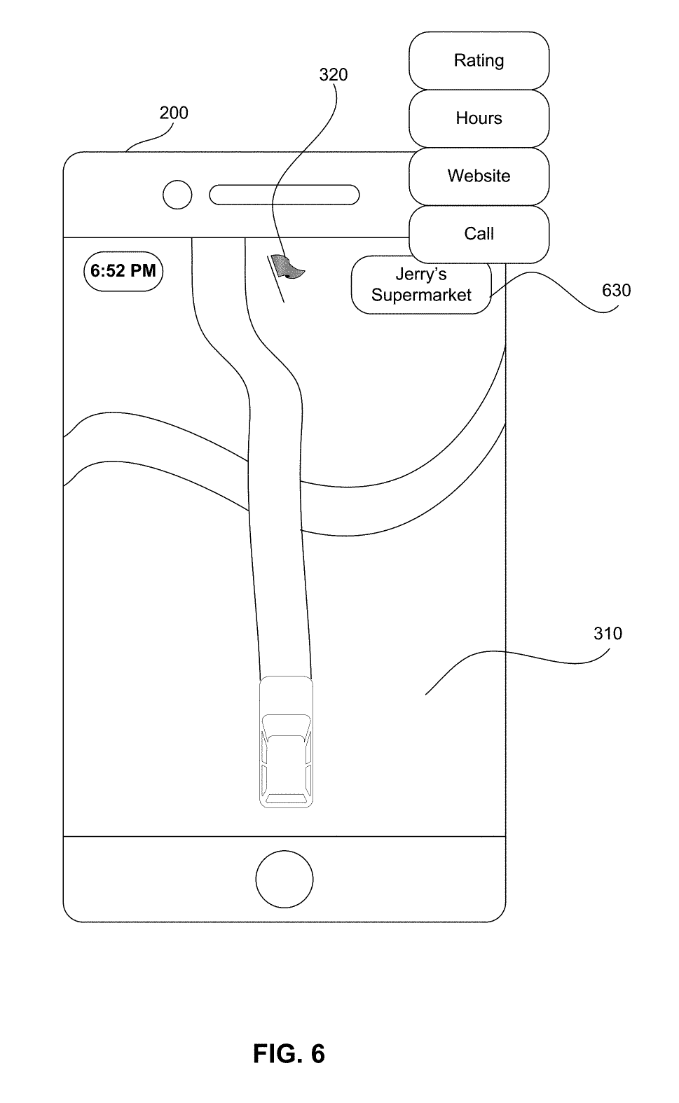

FIG. 6 illustrates a navigation UI 310 with a quick-access destination icon 630 providing multiple information and/or action options. The navigation UI 310 may be displayed on the display 230 of the device 200. As described above, a user of the device 200 may intend to begin a journey in his/her vehicle to a destination. Prior to, or at some time during, the user's journey, the user may input a destination location to the navigation application/software running on the device 200, via input device 240 or by touching the display 230. Upon receiving the user's input of the destination location, the route generation module 272 may generate a route from the current location of the mobile 200 to the destination location, as described above with respect to FIG. 2. Upon the route generation module 272 generating the route, the UI generation module 274 may generate a navigation UI 310 that includes a map of the area surrounding the device 200 and also indicating the route generated by the route generation module 272 from the location of the device 200 to the destination location 320. Further, the UI generation module 274 may generate a quick-access destination icon 630 configured to provide a two-touch input for the user to obtain information and/or execute an action pertaining to the destination location 320. For example, the quick-access destination icon 630 may be labeled with the name of destination location 320 (e.g., “Jerry's Supermarket”). The user may provide an input or touch to access the quick-access destination icon 630. Upon providing the input or touch for the quick-access destination icon 630, the navigation UI 310 may provide one or more additional icons that the user can access for obtaining information or executing an action pertaining to the destination location 320. For example, after providing an input or touch for the quick-access destination icon 630, the navigation UI 310 may display the following additional icons: “Rating”; “Hours”; “Website”; and “Call.” The user may then provide an input or touch for one of the additional icons to the obtain information or execute an action based on the particular function desired by the user. For example, the user may access the “Rating” icon to obtain a rating of the destination location 320, access the “Hours” icon to obtain the business hours of the destination location 320, access the “Website” icon to view a website associated with the destination location 320, or access the “Call” icon to place a phone call to the destination location 320. There also may be many different additional icons displayed to the user by the navigation UI 310 when the user provides an input or touch for the quick-access destination icon 630.

The quick-access destination icon 630 provides multiple options for the user to obtain desired information or to execute a desired command, while only having to provide two inputs or touches to the device 200. This may allow for a better user experience as navigating through many different sub-menus for the desired function may not be required. Additionally, the user may not be unnecessarily distracted from safely operating the vehicle for the same and other reasons.

Displaying the quick-access destination icon 630 within the UI 310 is an example of in response to at most one user input or without any user input, displaying at least one actionable function pertaining to the at least one destination location.

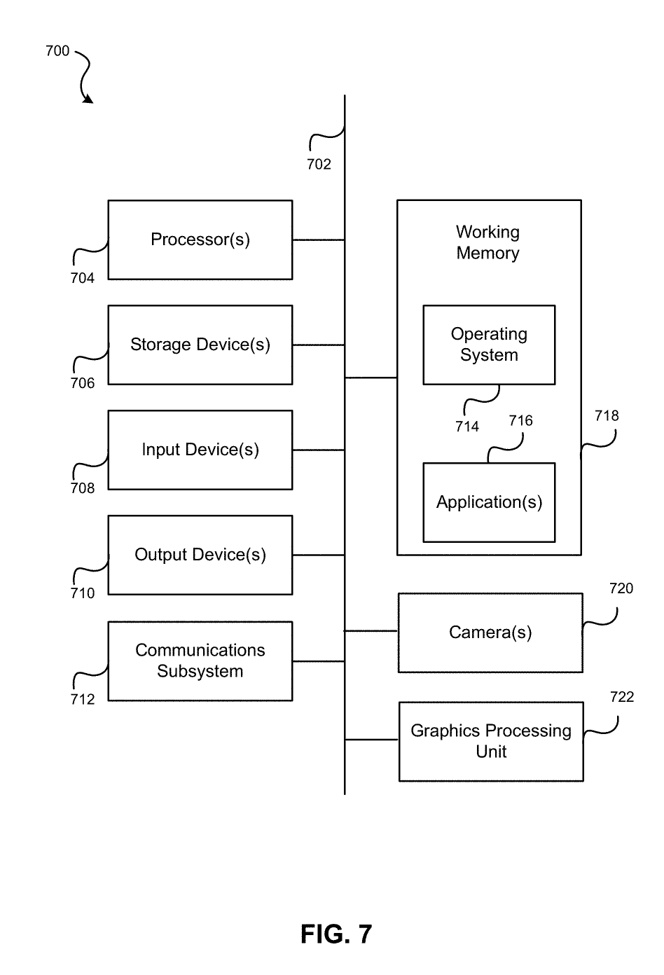

FIG. 7 illustrates an example of a computing system in which one or more embodiments may be implemented. A computer system as illustrated in FIG. 7 may be incorporated as part of the above described power control system. For example, computer system 700 can represent some of the components of a television, a computing device, a server, a desktop, a workstation, a control or interaction system in an automobile, a tablet, a netbook or any other suitable computing system. A computing device may be any computing device with an image capture device or input sensory unit and a user output device. An image capture device or input sensory unit may be a camera device. A user output device may be a display unit. Examples of a computing device include but are not limited to video game consoles, tablets, smart phones and any other hand-held devices. FIG. 7 provides a schematic illustration of one implementation of a computer system 700 that can perform the methods provided by various other implementations, as described herein, and/or can function as the host computer system, a remote kiosk/terminal, a point-of-sale device, a telephonic or navigation or multimedia interface in an automobile, a computing device, a set-top box, a table computer and/or a computer system. FIG. 7 is meant only to provide a generalized illustration of various components, any or all of which may be utilized as appropriate. FIG. 7, therefore, broadly illustrates how individual system elements may be implemented in a relatively separated or relatively more integrated manner.

The computer system 700 is shown comprising hardware elements that can be electrically coupled via a bus 702 (or may otherwise be in communication, as appropriate). The hardware elements may include one or more processors 704, including without limitation one or more general-purpose processors and/or one or more special-purpose processors (such as digital signal processing chips, graphics processing units 722, and/or the like); one or more input devices 708, which can include without limitation one or more cameras, sensors, a mouse, a keyboard, a microphone configured to detect ultrasound or other sounds, and/or the like; and one or more output devices 710, which can include without limitation a display unit such as the device used in implementations of the invention, a printer and/or the like. Additional cameras 720 may be employed for detection of user's extremities and gestures. In some implementations, input devices 708 may include one or more sensors such as infrared, depth, and/or ultrasound sensors. The graphics processing unit 722 may be used to carry out the method for real-time wiping and replacement of objects described above.

In some implementations of the implementations of the invention, various input devices 708 and output devices 710 may be embedded into interfaces such as display devices, tables, floors, walls, and window screens. Furthermore, input devices 708 and output devices 710 coupled to the processors may form multi-dimensional tracking systems.

The computer system 700 may further include (and/or be in communication with) one or more non-transitory storage devices 706, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 700 might also include a communications subsystem 712, which can include without limitation a modem, a network card (wireless or wired), an infrared communication device, a wireless communication device and/or chipset (such as a Bluetooth device, an 702.11 device, a WiFi device, a WiMax device, cellular communication facilities, etc.), and/or the like. The communications subsystem 712 may permit data to be exchanged with a network, other computer systems, and/or any other devices described herein. In many implementations, the computer system 700 will further comprise a non-transitory working memory 718, which can include a RAM or ROM device, as described above.

The computer system 700 also can comprise software elements, shown as being currently located within the working memory 718, including an operating system 714, device drivers, executable libraries, and/or other code, such as one or more application programs 716, which may comprise computer programs provided by various implementations, and/or may be designed to implement methods, and/or configure systems, provided by other implementations, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 706 described above. In some cases, the storage medium might be incorporated within a computer system, such as computer system 700. In other implementations, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which may be executable by the computer system 700 and/or might take the form of source and/or installable code, which, upon compilation and/or installation on the computer system 700 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed. In some implementations, one or more elements of the computer system 700 may be omitted or may be implemented separate from the illustrated system. For example, the processor 704 and/or other elements may be implemented separate from the input device 708. In one implementation, the processor may be configured to receive images from one or more cameras that are separately implemented. In some implementations, elements in addition to those illustrated in FIG. 2 may be included in the computer system 700.

Some implementations may employ a computer system (such as the computer system 700) to perform methods in accordance with the disclosure. For example, some or all of the procedures of the described methods may be performed by the computer system 700 in response to processor 704 executing one or more sequences of one or more instructions (which might be incorporated into the operating system 514 and/or other code, such as an application program 716) contained in the working memory 718. Such instructions may be read into the working memory 718 from another computer-readable medium, such as one or more of the storage device(s) 706. Merely by way of example, execution of the sequences of instructions contained in the working memory 718 might cause the processor(s) 704 to perform one or more procedures of the methods described herein.

The terms “machine-readable medium” and “computer-readable medium,” as used herein, refer to any medium that participates in providing data that causes a machine to operate in a specific fashion. In some implementations implemented using the computer system 700, various computer-readable media might be involved in providing instructions/code to processor(s) 704 for execution and/or might be used to store and/or carry such instructions/code (e.g., as signals). In many implementations, a computer-readable medium may be a physical and/or tangible storage medium. Such a medium may take many forms, including but not limited to, non-volatile media, volatile media, and transmission media. Non-volatile media include, for example, optical and/or magnetic disks, such as the storage device(s) 706. Volatile media include, without limitation, dynamic memory, such as the working memory 718. Transmission media include, without limitation, coaxial cables, copper wire and fiber optics, including the wires that comprise the bus 702, as well as the various components of the communications subsystem 712 (and/or the media by which the communications subsystem 712 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 704 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700. These signals, which might be in the form of electromagnetic signals, acoustic signals, optical signals and/or the like, are all examples of carrier waves on which instructions can be encoded, in accordance with various implementations of the invention.

The communications subsystem 712 (and/or components thereof) generally will receive the signals, and the bus 702 then might carry the signals (and/or the data, instructions, etc. carried by the signals) to the working memory 718, from which the processor(s) 704 retrieves and executes the instructions. The instructions received by the working memory 718 may optionally be stored on a non-transitory storage device 706 either before or after execution by the processor(s) 704.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Moreover, nothing disclosed herein is intended to be dedicated to the public.

While some examples of methods and systems herein are described in terms of software executing on various machines, the methods and systems may also be implemented as specifically-configured hardware, such as field-programmable gate array (FPGA) specifically to execute the various methods. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable storage media, that may store instructions that, when executed by the processor, can cause the processor to perform the steps described herein as carried out, or assisted, by a processor. Examples of computer-readable media may include, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

What is claimed is:

1. A method for providing a navigation route to a user, comprising:
receiving, via a device, an input indicative of at least one destination location;
generating, via a processor on the device, the navigation route from a source location to the at least one destination location;
displaying, within a user interface (UI) on a display of the device, the generated navigation route; and
in response to at most one user input or without any user input, displaying at least one actionable function pertaining to the at least one destination location, wherein the at least one actionable function is displayed within the UI during an ongoing navigation process, and wherein the at least one actionable function is selectable by the user.

2. The method of claim 1, further comprising preloading into a memory, via the processor, at least one item of information pertaining to the destination location.

3. The method of claim 1, wherein the at least one item of information comprises at least one of: a phone number of the at least one destination location, a website address of the at least one destination location, a business hours listing of the at least one destination location, a review rating of the at least one destination location, an e-mail address of the at least one destination location, or an address of the at least one destination location.

4. The method of claim 1, wherein the at least one actionable function is dynamically displayed within the UI.

5. The method of claim 1, wherein the at least one actionable function is displayed within the UI according to a semi-transparent fill factor.

6. The method of claim 1, wherein the at least one actionable function is selectable by the user via a voice command.

7. The method of claim 1, further comprising, in response to the user selecting the at least one actionable function, displaying, within the UI, one or more additional actionable functions pertaining to the at least one destination location.

8. A device for providing a navigation route to a user, comprising:
a processor; and
a computer readable medium coupled to the processor, the computer readable medium comprising code, executable by the processor, for implementing a method, comprising:
receiving an input indicative of at least one destination location;
generating the navigation route from a source location to the at least one destination location;
displaying within a user interface (UI) on a display of the device, the generated navigation route; and
in response to at most one user input or without any user input, displaying at least one actionable function pertaining to the at least one destination location, wherein the at least one actionable function is displayed within the UI during an ongoing navigation process, and wherein the at least one actionable function is selectable by the user.

9. The device of claim 8, wherein the method further comprises preloading into a memory, via the processor, at least one item of information pertaining to the destination location.

10. The device of claim 8, wherein the at least one item of information comprises at least one of: a phone number of the at least one destination location, a website address of the at least one destination location, a business hours listing of the at least one destination location, a review rating of the at least one destination location, an e-mail address of the at least one destination location, or an address of the at least one destination location.

11. The device of claim 8, wherein the at least one actionable function is dynamically displayed within the UI.

12. The device of claim 8, wherein the at least one actionable function is displayed within the UI according to a semi-transparent fill factor.

13. The device of claim 8, wherein the at least one actionable function is selectable by the user via a voice command.

14. The device of claim 8, wherein the method further comprises, in response to the user selecting the at least one actionable function, displaying, within the UI, one or more additional actionable functions pertaining to the at least one destination location.

15. An apparatus for providing a navigation route to a user, comprising:
means for receiving, via a device, an input indicative of at least one destination location;
means for generating, via a processor on the device, the navigation route from a source location to the at least one destination location;
means for displaying, within a user interface (UI) on a display of the device, the generated navigation route; and
in response to at most one user input or without any user input, displaying at least one actionable function pertaining to the at least one destination location, wherein the at least one actionable function is displayed within the UI during an ongoing navigation process, and wherein the at least one actionable function is selectable by the user.

16. The apparatus of claim 15, further comprising means for preloading into a memory, via the processor, at least one item of information pertaining to the destination location.

17. The apparatus of claim 15, wherein the at least one item of information comprises at least one of: a phone number of the at least one destination location, a website address of the at least one destination location, a business hours listing of the at least one destination location, a review rating of the at least one destination location, an e-mail address of the at least one destination location, or an address of the at least one destination location.

18. The apparatus of claim 15, wherein the at least one actionable function is dynamically displayed within the UI.

19. The apparatus of claim 15, wherein the at least one actionable function is displayed within the UI according to a semi-transparent fill factor.

20. The apparatus of claim 15, wherein the at least one actionable function is selectable by the user via a voice command.
